(19) United States
(12) Patent Application Publication
(10) Pub. No.: US 2026/0208970 A1
(43) Pub. Date: Jul. 23, 2026

(54) SYSTEMS AND METHODS TO ORGANIZE INDUSTRIAL COMPONENTS

(71) Applicant: SAMUEL, SON & CO. (USA) INC., Woodridge, IL (US)

(72) Inventor: George NECHANICKY, Elmira (CA)

(73) Assignee: SAMUEL, SON & CO. (USA) INC., Woodridge, IL (US)

(21) Appl. No.: 19/027,399

(22) Filed: Jan. 17, 2025

(51) Int. Cl. B65G 47/256; B65G 47/12

(52) U.S. Cl. CPC B65G 47/256; B65G 47/12; B65G 2203/0225

(57) ABSTRACT

Systems, methods, and apparatuses of organizing industrial components are provided. At least one aspect is directed to an apparatus to organize industrial components. The apparatus includes a first conveyor belt, a second conveyor belt spaced apart from the first conveyor belt, and a drive unit coupled with the first conveyor belt and the second conveyor belt. The first conveyor belt and the second conveyor belt are to receive a first industrial component having a first orientation and a second industrial component having a second orientation different than the first orientation. The apparatus includes a filter to apply a force to the first industrial component based on the first orientation to remove the first industrial component from the first conveyor belt and from the second conveyor belt and the filter is to allow, based on the second orientation, the second industrial component to pass a location of the filter.

### BACKGROUND

In a manufacturing environment, various objects can be moved from a first location to a second location.

### SUMMARY

At least one aspect is directed to an apparatus to organize industrial components. The apparatus includes a first conveyor belt, a second conveyor belt spaced apart from the first conveyor belt, and a drive unit coupled with the first conveyor belt and the second conveyor belt. The first conveyor belt and the second conveyor belt are to receive a first industrial component having a first orientation and the first conveyor belt and the second conveyor belt to receive a second industrial component having a second orientation different than the first orientation. The apparatus includes a filter to apply a force to the first industrial component based on the first orientation to remove the first industrial component from the first conveyor belt and from the second conveyor belt and the filter is to allow, based on the second orientation, the second industrial component to pass a location of the filter.

At least one aspect is directed to a method of organizing industrial components with an apparatus, including providing a first conveyor belt, providing a second conveyor belt spaced apart from the first conveyor belt, and coupling at least one drive unit with the first conveyor belt and the second conveyor belt, at least one of the first conveyor belt or the second conveyor belt is a non-linear conveyor belt. The method includes receiving, by the first conveyor belt and the second conveyor belt, a first industrial component having a first orientation, and receiving, by the first conveyor belt and the second conveyor belt, a second industrial component having a second orientation. The method includes applying, by a filter, a force to the first industrial component based on the first orientation to remove the first industrial component from the first conveyor belt and from the second conveyor belt and allowing, by the filter, the second industrial component, based on the second orientation, to pass a location of the filter.

At least one aspect is directed to a method including providing an apparatus to organize industrial components. The apparatus includes a first conveyor belt, a second conveyor belt spaced apart from the first conveyor belt, and a drive unit coupled with the first conveyor belt and the second conveyor belt. The first conveyor belt and the second conveyor belt to receive a first industrial component having a first orientation and the first conveyor belt and the second conveyor belt to receive a second industrial component having a second orientation different than the first orientation. The apparatus includes a filter to apply a force to the first industrial component based on the first orientation to remove the first industrial component from the first conveyor belt and from the second conveyor belt and the filter to allow, based on the second orientation, the second industrial component to pass a location of the filter.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example apparatus to organize industrial components.

FIG. 2 depicts the example apparatus of FIG. 1

FIG. 3 depicts a partial top view of the example apparatus of FIG. 1

FIG. 4 depicts a detail view of a filter of the example apparatus of FIG. 1.

FIG. 5 depicts a detail view of a filter of the example apparatus of FIG. 1.

FIG. 6 depicts a detail view of a handling system of the example apparatus of FIG. 1.

FIG. 7 depicts a detail view of a container of the example apparatus of FIG. 1.

FIG. 8A depicts a detail view of a transport element of the example apparatus of FIG. 1 in a first position.

FIG. 8B depicts a detail view of a transport element of the example apparatus of FIG. 1 in a second position.

FIG. 9A depicts the example apparatus of FIG. 1 with a funneling member.

FIG. 9B depicts a detail view of the funneling member of FIG. 9A.

FIG. 10 depicts an example apparatus to organize industrial components.

FIG. 11 depicts a detail view of a filter of the example apparatus of FIG. 10.

FIG. 12 depicts a detail view of a filter of the example apparatus of FIG. 10.

FIG. 13 depicts a detail view of a container of the example apparatus of FIG. 10.

FIG. 14 depicts a detail view of a container and a transport element of the example apparatus of FIG. 10.

FIG. 15 depicts a detail view of a transport element of the example apparatus of FIG. 10.

FIG. 16 depicts a detail view of a handling system of the example apparatus of FIG. 10.

FIG. 17 depicts an example method of organizing industrial components.

FIG. 18 depicts am example method of providing an apparatus to organize industrial components.

### DETAILED DESCRIPTION

Following below are more detailed descriptions of various concepts related to, and implementations of an apparatus. The apparatus can organize industrials components, such as a dowel. The various concepts introduced above and discussed in greater detail below can be implemented in any of numerous ways.

An apparatus to organize industrial components is vital in a manufacturing environment (e.g., automobile or other assembly lines, etc.) for efficiently organizing the needed parts. Apparatuses to organize industrial components can include vibratory systems that may be effective for clean and dry industrial components. However, when industrial components are covered in material, such as oil, grease, and rust inhibitor, the material dampens the vibratory effect and can lead to ineffective organizing. For example, an industrial component covered in rust inhibitor on the apparatus can, after time, remain stationary rather than vibrate due to the dampening of the vibratory system. Industrial components that have a low mass can be difficult to organize with the apparatus as the vibrations on the vibratory system may have a greater effect than on industrial components that a higher mass.

The problems with apparatuses to organize industrial components that include vibratory systems can include requiring frequent cleaning of the apparatus. For example, when the vibratory effect is dampened, cleaning on the apparatus is required such that the apparatus can continue to perform as needed. This frequent cleaning is not routine as it can happen at any time and reaction from a user of apparatus is necessary when it occurs. This can lead to additional labor from the user and a longer time needed to organize industrial components.

At least one technical solution provided by apparatus to organize industrial components as described herein addresses the issues discussed by using a conveyance system that allows for filtering. The conveyance system can include at least two conveyor belts that are in operation to ensure that the industrial components are in motion. The lack of the vibratory system in the apparatus eliminates issues dependent on a mass of the industrial components and a material that the industrial components may be covered in, among others. The conveyance system in the apparatus allows for industrial components to be moved from a first location to a second location at a wide range of distances. In apparatuses that include vibratory systems, depending on a distance of the first location to the second location, more than one vibratory system may be needed to ensure the vibratory effect remains consistent along a path from the first location to the second location. Systems and methods described herein can solve these and other technical problems by including a conveyance system that allows for filtering to organize industrial components.

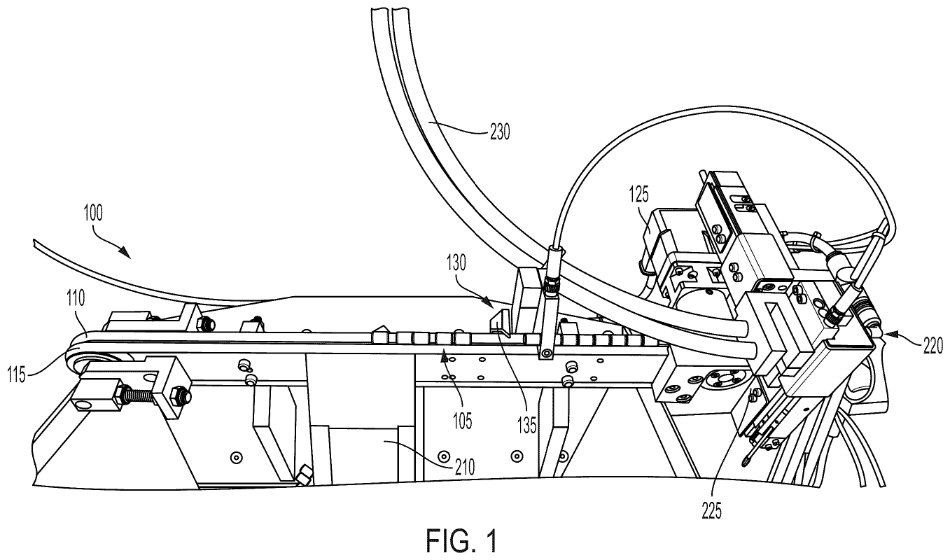

FIG. 1 depicts an example apparatus 100 to organize industrial components. For example, the apparatus 100 can be a machine or an assembly. The apparatus 100 can be in an industrial environment. For example, the apparatus 100 can be used in a factory or a supply chain environment. The apparatus 100 can be used to line up components for assembly or manufacturing of a machine, a second apparatus, or an automobile, among others.

The apparatus 100 organizes industrial components 105. For example, the industrial components 105 can include a dowel, a fastener, a screw, a bolt, a nut, a pin, a rod, or a cylindrical stud. The industrial components 105 can be manufactured from metal, plastics, wood, or some combination thereof, among others. The industrial components 105 can have a variety of shapes, such as cylindrical, rectangular, or spherical, among others. The industrial components 105 can be hollow or solid. The industrial components 105 can be covered with a material, such as rust inhibitor, grease, and oil, among others. The industrial components 105 can have a wide range of mass, widths, and heights, among others.

The apparatus 100 can include at least one first conveyor belt 110. For example, the first conveyor belt 110 can span from a first location to a second location. The first conveyor belt 110 can be continuous. For example, the first conveyor belt 110 can include a belt that continuously spans from the first location to the second location. The first conveyor belt 110 can be noncontinuous. For example, the first conveyor belt 110 can include a number of sliders that spans from the first location to the second location. The first conveyor belt 110 can be manufactured from rubber, plastics, elastics, or some combination thereof, among other. For example, the first conveyor belt 110 can be manufactured from urethane or butylene. The first conveyor belt 110 can be driven by wheels, rollers, a pulley system, or some combination thereof, among others. The first conveyor belt 110 can include a flat bed. For example, the first conveyor belt 110 can include a flat bed and be horizontal along a longitudinal axis of the first conveyor belt 110. The first conveyor belt 110 can include at least a portion that is angled upwards or downwards with respect to the longitudinal length. As depicted in FIG. 1, among others, the first conveyor belt 110 can have a radius. For example, the first conveyor belt 110 can be cylindrical. The first conveyor belt 110 can be non-linear along the longitudinal axis of the first conveyor belt 110. For example, at least a portion of a path the first conveyor belt 110 travels (e.g., from the first location to the second location) can be curved. The first conveyor belt 110 can have a S-curve, a U-shape, a horseshoe shape, a helix shape, or some combination thereof, among others. The first conveyor belt 110 can be straight along the longitudinal axis.

The apparatus 100 can include at least one second conveyor belt 115. For example, the second conveyor belt 115 can span from a third location to a fourth location. The third location and the fourth location can be the first location and the second location, respectively of the first conveyor belt 110. The second conveyor belt 115 can be a same type or a different type as the first conveyor belt 110. The second conveyor belt 115 can be spaced apart from the first conveyor belt 110. Spacing between the first conveyor belt 110 and the second conveyor belt 115 can allow for debris to fall through. For example, for industrial components 105 covered in material, at least some of the material from the industrial components 105 can drip off and through the first conveyor belt 110 and the second conveyor belt 115, which can reduce the debris on the first conveyor belt 110 and the second conveyor belt 115. The first conveyor belt 110 and the second conveyor belt 115 can have substantially no spacing between the first conveyor belt 110 and the second conveyor belt 115. Spacing determinations can be dependent on a size of the industrial components 105. For example, industrial components 105 with a larger width can have a greater spacing between the first conveyor belt 110 and the second conveyor belt 115 than industrial components 105 with a smaller width.

The apparatus 100 can include at least one base 120. For example, the base 120 can be a post on a ground that the apparatus 100 is supported on. The base 120 can be a bottom of the apparatus 100. For example, the base 120 can be a bottom of the first conveyor belt 110, a bottom of the second conveyor belt 115, or a bottom of another component of the apparatus 100.

The first conveyor belt 110 can have a first height from the base 120. The first height can be a distance from the first conveyor belt 110 to the base 120. The second conveyor belt 115 can have a second height from the base 120. The second height can be a distance from the second conveyor belt 115 to the base. The second height can be equal to the first height. For example, the first conveyor belt 110 and the second conveyor belt 115 can be on a same plane that is parallel with a plane of the base 120 or a plane of the ground. The second height and the first height can be different. For example, the first height can be greater than the second height. The first conveyor belt 110 can be on a first plane that is parallel with a plane of the base 120 and the second conveyor belt 115 can be on a second plane that is parallel with the plane of the base 120. The first plane and the second plane can be different such that the first conveyor belt 110 and the second conveyor belt 115 are on planes that do not intersect (e.g., skewed parallel planes, uneven parallel planes, etc.). The second height can be greater than the first height. The difference of the first height and the second height can aid in organizing the industrial components 105. For example, an industrial component 105 not in proper alignment can fall off the first conveyor belt 110 and the second conveyor belt 115.

The apparatus 100 can include at least one drive unit 125. For example, the drive unit 125 can be coupled with the first conveyor belt 110 and the second conveyor belt 115. The drive unit 125 can include a first drive unit and a second drive unit. For example, the first drive unit can be coupled with the first conveyor belt 110 and the second drive unit can be coupled with the second conveyor belt 115. The drive unit can be a powertrain system or an engine, among others to provide operation to the apparatus 100.

The drive unit 125 can drive the first conveyor belt 110 and the second conveyor belt 115 to operate. For example, the drive unit 125 can drive the first conveyor belt 110 to operate at a first speed. The drive unit 125 can drive the first conveyor belt 110 to operate at a second speed different from the first speed. The second speed can be the same as the first speed to drive the first conveyor belt 110 and the second conveyor belt 115 at the same speed. The first speed and the second speed can be chosen dependent on the industrial components 105 to organize or an application for organizing the industrial components 105. For example, the first speed and the second speed can be between 1 feet per second (ft/s) and 20 ft/s. The first speed and the second speed can be adjusted to a slower speed if a user of the apparatus 100 is required to check the industrial components 105 before the industrial components 105 exit the apparatus 100. The drive unit 125 can include a motor. For example, the motor can cause the first conveyor belt 110 and the second conveyor belt 115 to operate at the first speed and the second speed, respectively.

The apparatus 100 can receive a first industrial component 105. For example, the first conveyor belt 110 and the second conveyor belt 115 can receive the first industrial component 105. The first industrial component 105 can have a first orientation 405 when received by the first conveyor belt 110 and the second conveyor belt 115. For example, the first industrial component 105 can have an orientation different from the first orientation 405 before the first conveyor belt 110 and the second conveyor belt 115 are to receive the first industrial component 105. The first industrial component 105 can have an orientation before the first conveyor belt 110 and the second conveyor belt 115 are to receive the first industrial component 105 that is the same as the first orientation 405. The first industrial component 105 can have an orientation when received by the apparatus 100 that is different than the first orientation 405 that is received by the first conveyor belt 110 and the second conveyor belt 115.

The apparatus 100 can receive a second industrial component 105. For example, the first conveyor belt 110 and the second conveyor belt 115 can receive the second industrial component 105. The second industrial component 105 can have a second orientation 505 when received by the first conveyor belt 110 and the second conveyor belt 115. For example, the second industrial component 105 can have an orientation different from the second orientation 505 before the first conveyor belt 110 and the second conveyor belt 115 are to receive the second industrial component 105. The second industrial component 105 can have an orientation before the first conveyor belt 110 and the second conveyor belt 115 are to receive the second industrial component 105 that is the same as the second orientation 505. The second orientation 505 is different than the first orientation 405.

The apparatus 100 can include at least one filter 130. The filter 130 can selectively remove the industrial components 105 from the first conveyor belt 110 and the second conveyor belt 115. For example, the filter 130 can apply a force to the first industrial component 105 based on the first orientation 405. The force applied can remove the first industrial component 105 from the first conveyor belt 110 and the second conveyor belt 115. For example, the first orientation 405 can be an orientation that is not desired by a user of the apparatus 100 and the filter 130 can remove the first industrial component 105 from the first conveyor belt 110 and the second conveyor belt 115 to effectively organize the industrial components 105.

The filter 130 can allow the second industrial component 105 to pass a location of the filter 130 based on the second orientation 505. For example, the filter 130 can apply a force to the second industrial component 105 that does not remove the second industrial component 105 from the first conveyor belt 110 and the second conveyor belt 115. For example, the second orientation 505 can be an orientation that is desired by the user of the apparatus 100 for use of the industrial components 105 in an application.

The filter 130 can include at least one of a pneumatic filter or a mechanical filter. The filter 130 can be fixed at a location. For example, the filter can be fixedly coupled at a location on the apparatus 100. The filter 130 can move between a range of locations. For example, the filter 130 can be a sweeper. The filter 130 can move laterally along a longitudinal length of the first conveyor belt 110 and the second conveyor belt 115.

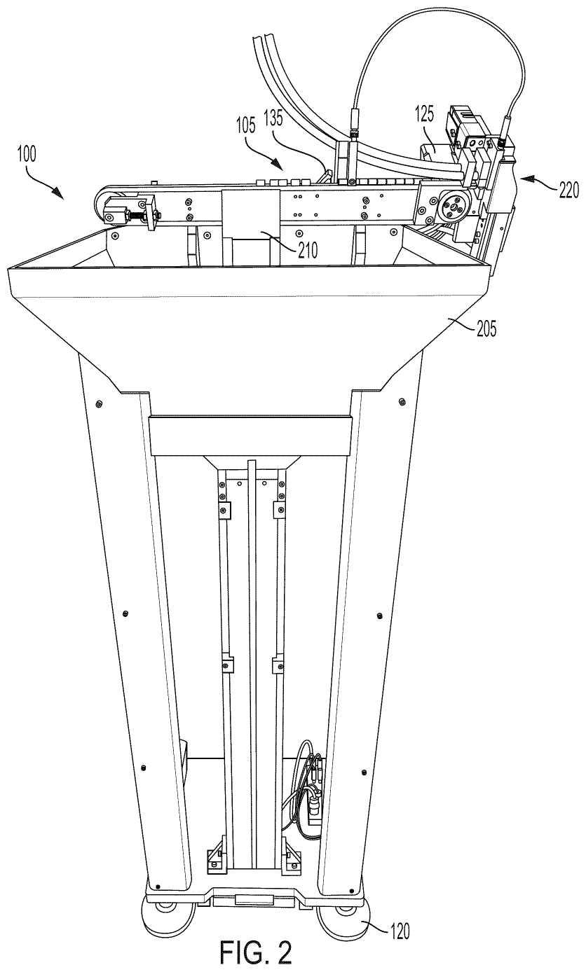

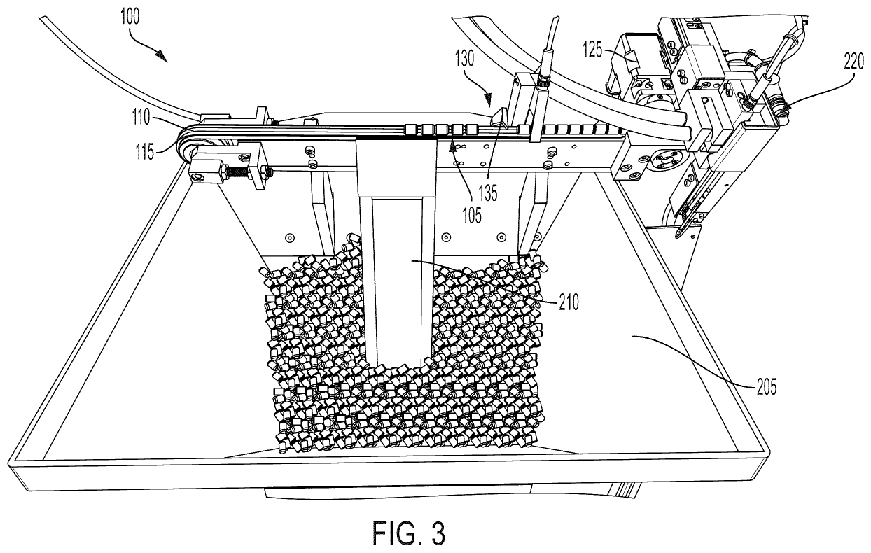

As depicted in FIG. 2-5, among others, the filter 130 can include at least one mechanical filter. For example, the mechanical filter can be a structural blocker 135 positioned along a longitudinal length of the first conveyor belt 110 and the second conveyor belt 115. The structural blocker 135 can be manufactured from metal, among other. The mechanical filter can include an opening for industrial components 105 to pass through.

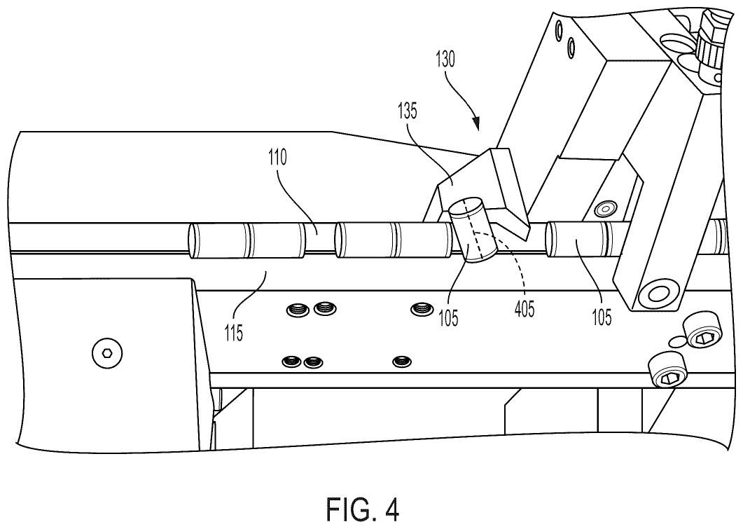

As depicted in FIG. 4, among others, the mechanical filter can prevent the first industrial component 105 from passing the location of the filter 130. For example, the structural blocker 135 of the mechanical filter can remove the first industrial component 105 from the first conveyor belt 110 and the second conveyor belt 115. The structural blocker 135 can contact the first industrial component 105 to remove the first industrial component 105.

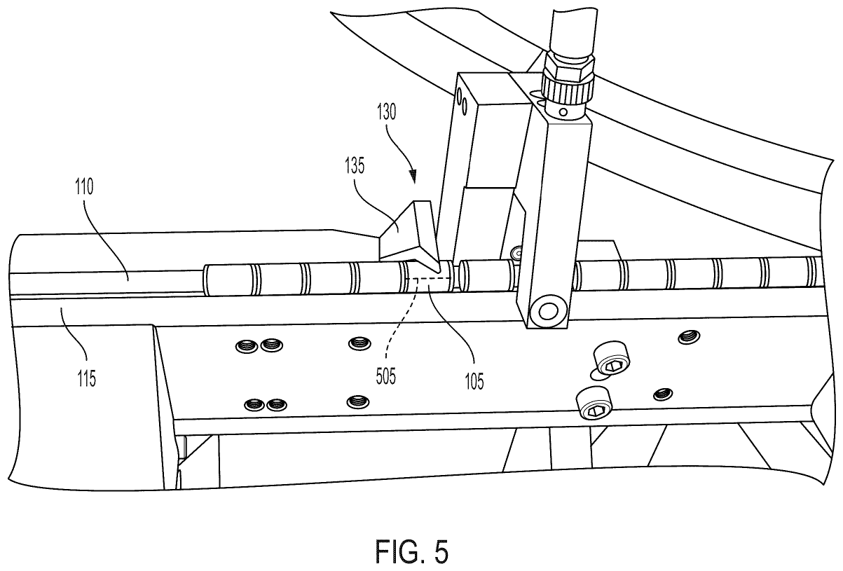

As depicted in FIG. 5, among others, the mechanical filter can allow the second industrial component 105 to pass the location of the filter 130. For example, the second orientation 505 of the second industrial component 105 can fit into the mechanical filter such that the second industrial component 105 can pass the location of the filter 130.

The apparatus can receive a third industrial component 105. For example, the first conveyor belt 110 and the second conveyor belt 115 can receive the third industrial component 105. The third industrial component 105 can have a third orientation when received by the first conveyor belt 110 and the second conveyor belt 115. For example, the third industrial component 105 can have an orientation different from the third orientation before the first conveyor belt 110 and the second conveyor belt 115 are to receive the third industrial component 105. The mechanical filter can contact the third industrial component 105 to move the third industrial component 105 to have the second orientation 505. For example, as depicted in FIGS. 4 and 5, among others, the mechanical filter can include a curved or non-flat portion that can aid in moving the third industrial component 105 to have the second orientation 505. The mechanical filter can then allow the third industrial component 105 to pass a first location of the mechanical filter based on the third industrial component 105 having the second orientation 505. For example, the first location of the mechanical filter can be at a same location as the location of the filter 130.

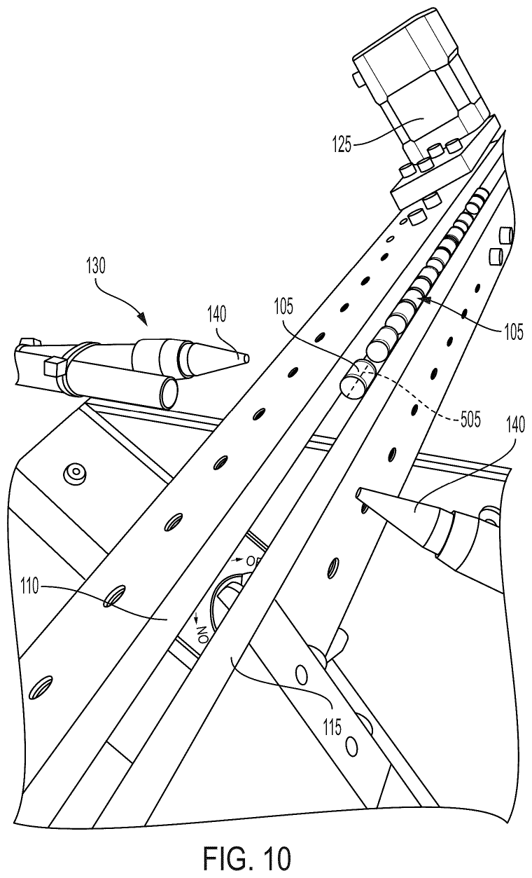

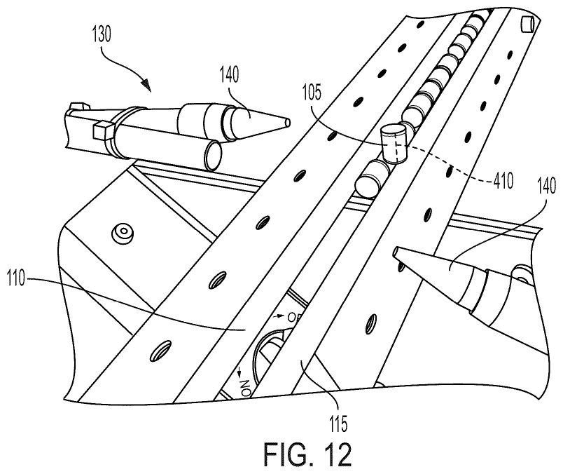

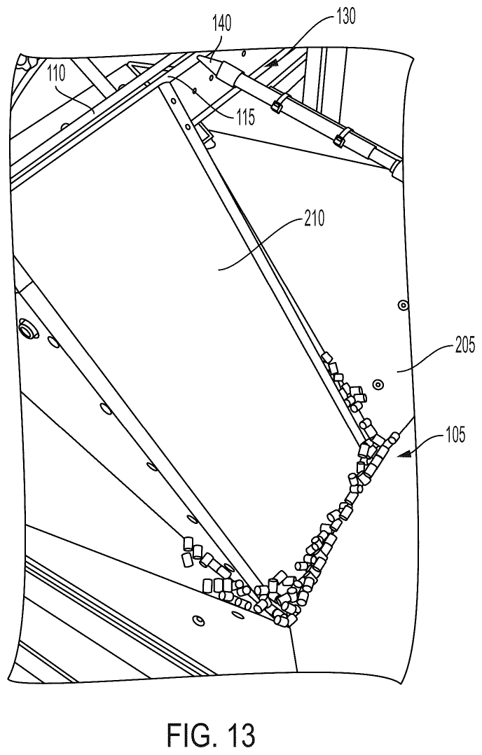

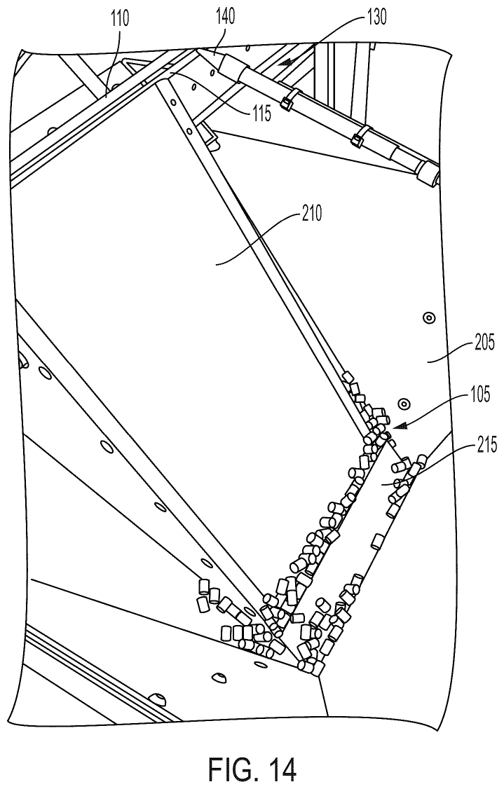

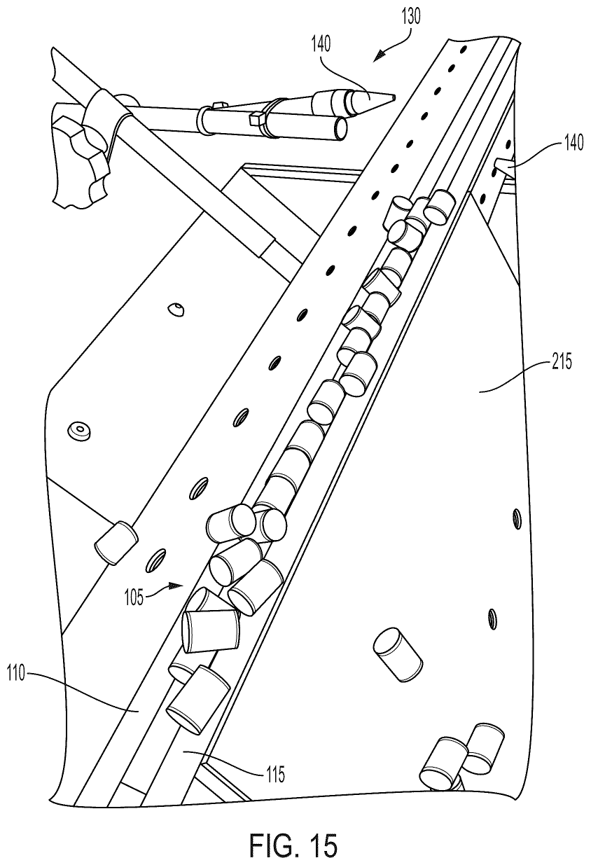

As depicted in FIG. 10-15, among others, the filter 130 can include at least one pneumatic filter. For example, the pneumatic filter can include a nozzle 140 that outputs a stream of gas (e.g., air, etc.). to selectively filter and organize the industrial components 105. The steam outputted form the nozzle 140 can apply the force to the industrial components 105 to remove the industrial components 105 from the first conveyor belt 110 and the second conveyor belt 115 to selectively filter the industrial components 105.

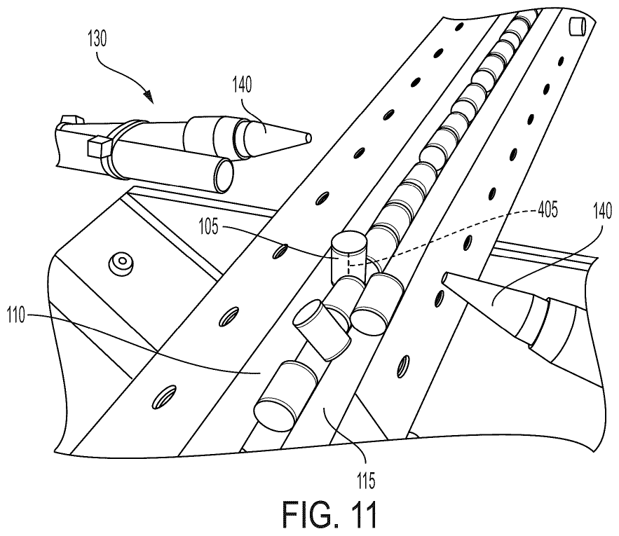

As depicted in FIGS. 10 and 11, among others, the filter 130 can include a first pneumatic filter. The first pneumatic filter can be positioned at a first location. For example, the first location can be along a first side of the first conveyor belt 110 and the second conveyor belt 115. The first side can be along the longitudinal length of the first conveyor belt 110 and the second conveyor belt 115.

The apparatus 100 can include at least one second pneumatic filter. For example, the filter 130 can include the second pneumatic filter. The second pneumatic filter can be at a second location. For example, the second location can be different than the first location of the first pneumatic filter. The second location can be along a second side of the first conveyor belt 110 and the second conveyor belt 115. The second side can be along the longitudinal length of the first conveyor belt 110 and the second conveyor belt 115, and different than the first side. The first pneumatic filter and the second pneumatic filter can be positioned such that a first airstream from the nozzle 140 of the first pneumatic filter does not interfere with a second airstream from the nozzle 140 of the second pneumatic filter.

As depicted in FIGS. 10-12, among others, the first pneumatic filter and the second pneumatic filter can selectively filter and organize the industrial components 105. The first pneumatic filter can apply a first force to the first industrial component 105. For example, the first force can be a stream of air. Based on the first orientation 405 of the first industrial component 105, the first pneumatic filter removes the first industrial component 105 from the first conveyor belt 110 and the second conveyor belt 115.

The apparatus 100 can receive the third industrial component 105. For example, the first conveyor belt 110 and the second conveyor belt 115 can receive the third orientation component 105 at a third orientation 410. For example, the third orientation 410 can be different than the first orientation 405. The third orientation 410 can be the same as the first orientation 405. The first pneumatic filter can allow the third industrial component 105 to pass the first location of the first pneumatic filter. For example, a stream of air from the first pneumatic filter can be at an angle, direction, power, or any combination thereof, among others, that does not remove the third industrial component 105 from the first conveyor belt 110 and the second conveyor belt 115.

The second pneumatic filter can apply a second force to the third industrial component 105. For example, the second force can be a stream of air. The second force can be different than the first force. For example, the second force can be a weaker or stronger stream of air. The second force can be a same type as the first force. The second pneumatic filter can apply the second force to the third industrial component 105 to remove the third industrial component from the first conveyor belt 110 and the second conveyor belt 115 based on the third orientation 410. As such, the first pneumatic filter can remove a first number of industrial components 105 at varying orientations (e.g., the first orientation 405, etc.) and the second pneumatic filter can remove a second number of industrial components 105 at varying orientations (e.g., the third orientation 410, etc.).

The pneumatic filter can be adjusted to filter and organize the industrial components 105. For example, the pneumatic filter can apply the force at an angle. The angle can be relative to a longitudinal axis of the first conveyor belt 110. In another example, the pneumatic filter can have a height from the base 120 that is less than the first height of the first conveyor belt 110. In this way, configurations of the pneumatic filter can be used to filter and organize the industrial components 105 as necessary.

The first conveyor belt 110 and the second conveyor belt 115 can receive a fourth industrial component 105. The fourth industrial component 105 can have a fourth orientation on the first conveyor belt 110 and the second conveyor belt 115. For example, the fourth industrial component 105 can have an orientation before received by the first conveyor belt 110 and the second conveyor belt 115 that is different than the fourth orientation. The pneumatic filter can remove the third industrial component 105 from the first conveyor belt 110 and the second conveyor belt 115. For example, based on the angle of the pneumatic filter, the third industrial component 105 can be removed from the first conveyor belt 110 and the second conveyor belt 115.

As depicted in FIG. 2, among others, the apparatus 100 can include at least one container 205. For example, the container 205 can be a bucket or a storage unit, among others. The container 205 can store industrial components 105. For example, the container 205 can store the first industrial component 105 and the second industrial component 105. The first conveyor belt 110 and the second conveyor belt 115 can receive the industrial components 105 (e.g., the first industrial component 105, the second industrial component 105, the third industrial component 105, etc.) from the container 205.

The container 205 can provide a recirculating process for the industrial components 105. For example, the filter 130 can remove the first industrial component 105 from the first conveyor belt 110 and the second conveyor belt 115 into the container 205. In this way, the first industrial component 105 can eventually be received again by the first conveyor belt 110 and the second conveyor belt 115. For example, the first industrial component 105 can be received a second time by the first conveyor belt 110 and the second conveyor belt 115 at a location along the path of the first conveyor belt 110 before the location of the filter 130. For example, the first industrial component 105 can be received a second time by the first conveyor belt 110 and the second conveyor belt 115 at an orientation different from the first orientation 405 to pass the location of the filter 130.

The apparatus 100 can include at least one transport element 210. For example, the transport element 210 can be electronically controlled or manually controlled. The transport element 210 can be a step feeder. A second motor can drive operation of the transport element 210. The transport element 210 can transport industrial components 105 to the first conveyor belt 110 and the second conveyor belt 115. For example, the transport element 210 can transport industrial components 105 from a first position to the first conveyor belt 110 and the second conveyor belt 115. The first position can be a position not on the first conveyor belt 110 and the second conveyor belt 115.

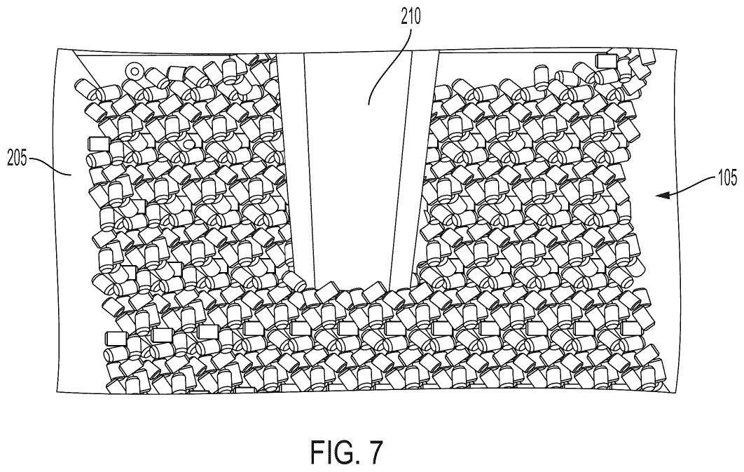

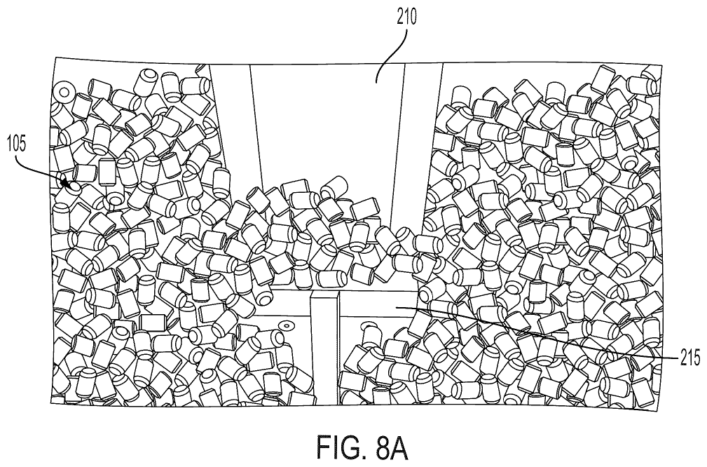

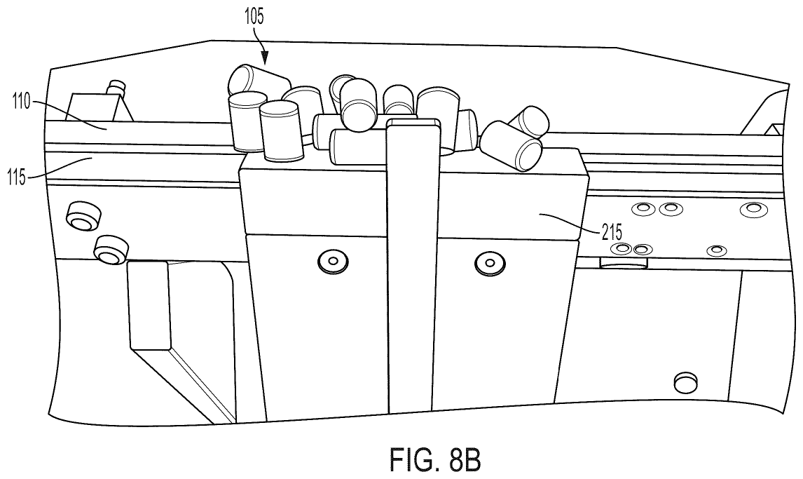

As depicted in FIGS. 7, 8A, and 8B, among others, the transport element 210 can receive the industrial components 105 from the container 205. For example, the transport element 210 can include a projection 215 that collects at least a portion of the industrial components 105 in the container 205 and transports the industrial components 105 to the first conveyor belt 110 and the second conveyor belt 115. The projection 215 can move back to the container 205 to collect a second portion of the industrial components 105 and transport the second portion of the industrial components 105 to the first conveyor belt 110 and the second conveyor belt 115. For example, the transport element 210 or the projection 215 can receive the first industrial component 105 and the second industrial component 105 from the container 205 and transport the first industrial component 105 and the second industrial component 105 to the first conveyor belt 110 and the second conveyor belt 115. In this way, the combination of the container 205 and the transport element 210 can provide a constant process for organizing the industrial components 105. For example, the industrial components 105 are constantly being received from the container 205 by the transport element 210 and organized. For example, the industrial components 105 can pass the location of the filter 130 or be removed by the filter 130 into the container 205 to be recollected by the transport element 210 and placed back onto the first conveyor belt 110 and the second conveyor belt 115. This constant process can occur until an entirety of the industrial components 105 are organized (e.g., the container 205 has no industrial components 105).

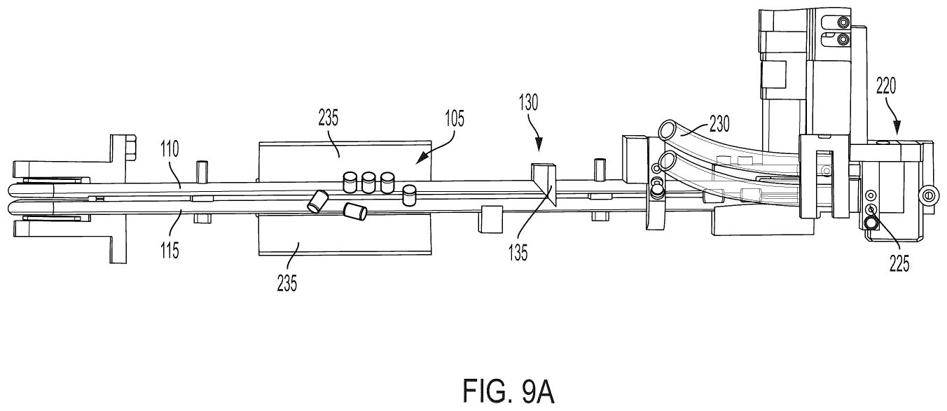

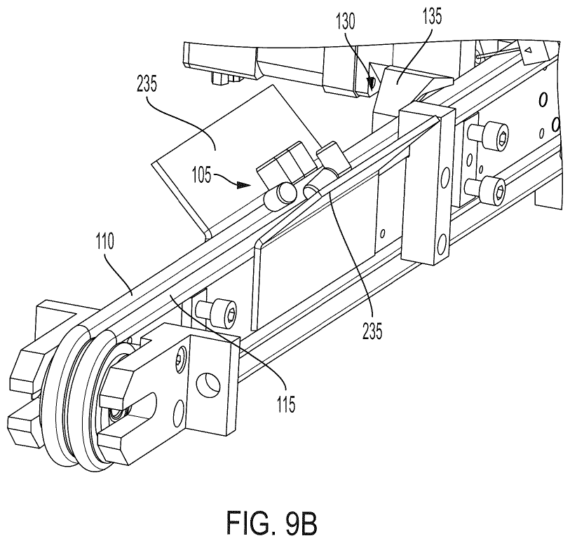

As depicted in FIGS. 9A and 9B, among others, the apparatus 100 can include at least one funneling member 235. For example, the funneling member 235 can be a funnel, a ramp, a second filter, or any combination thereof, among others. The funneling member 235 can be flat or have a curvature (e.g., conoid, semicylindrical, etc.). The funneling member 235 can be positioned on a first side of the first conveyor belt 110 and the second conveyor belt 115. The funneling member 235 can be positioned on a second side of the first conveyor belt 110 and the second conveyor belt 115 different than the first side. The funneling member 235 can be positioned on both the first side and the second side of the first conveyor belt 110 and the second conveyor belt 115. The funneling member 235 can be coupled to at least one of the first conveyor belt 110 and the second conveyor belt 115. The first conveyor belt 110 and the second conveyor belt 115 can receive the industrial components 105 (e.g., the first industrial component 105, the second industrial component 105) from the funneling member 235.

As depicted in FIGS. 9A and 9B, among others, the funneling member 235 can receive a third industrial component 105. For example, the third industrial component 105 can have a third orientation on the funneling member 235 that is different that the second orientation 505. The third orientation can be a same orientation as the first orientation 405. Based on the third orientation, the funneling member 235 can apply a force to the third industrial component 105. The force applied by the funneling member 235 can move the third orientation of the third industrial component 105 to the second orientation 505 such that the first conveyor belt 110 and the second conveyor belt 115 can receive the third industrial component 105 having the second orientation 505. The third industrial component 105 having the second orientation 505 on the first conveyor belt 110 and the second conveyor belt 115 can allow the third industrial component 105 to pass the location of the filter 130. In this way, the funneling member provides a way for at least a portion of the industrial components 105 to be adjusted to an orientation that passes the location of the filter 130 (e.g., the second orientation 505) prior to the industrial components 105 being received by the first conveyor belt 110 and the second conveyor belt 115.

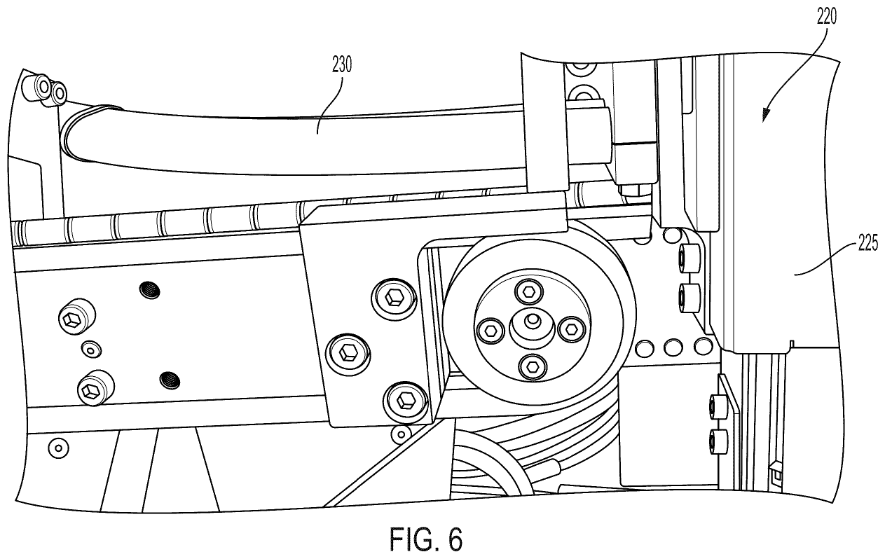

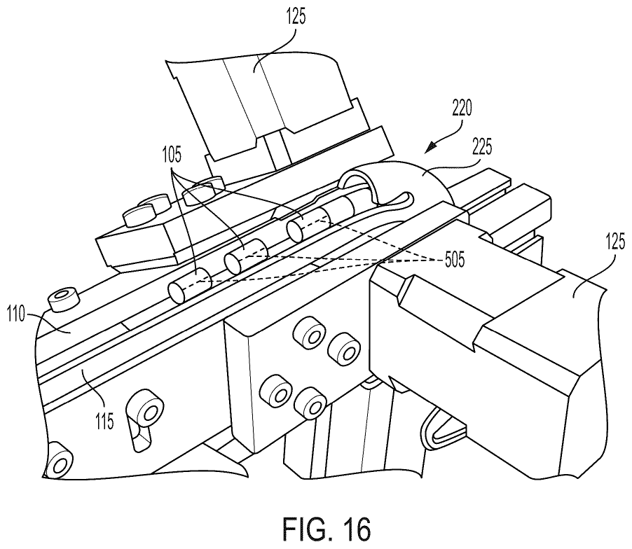

As depicted in FIGS. 6 and 16, among others, the apparatus 100 can include at least one handling system 220. For example, the handling system 220 can be a system to transport the industrial components 105 that pass the filter 130. The handling system 220 can be coupled to the first conveyor belt 110 and the second conveyor belt 115. The handling system 220 can include a collector 225. For example, the collector 225 can be a singulator that can collect the industrial components 105 from the first conveyor belt 110 and the second conveyor belt 115 in an orderly and arranged process. The collector 225 can feed the industrial components 105 to a tubing system 230. The tubing system 230 can include an airstream. For example, the airstream can blow air in the tubing system 230 to transport the industrial components 105. The airstream can transport the industrial components 105 to a second apparatus. For example, the second apparatus can be a gripper. The gripper can transport the industrial components 105 to a hole, an opening, among others, such that the industrial components 105 can be pressed into the hole. As such, industrial components 105 after being organized on the apparatus 100 can be used in applications for manufacturing larger components.

The handling system 220 can be positioned at a location past the filter 130. For example, the second industrial component 105, after passing the location of the filter 130, can be received by the handling system 220. The handling system 220 can remove the second industrial component 105 from the first conveyor belt 110 and the second conveyor belt 115 as described herein to transport the industrial components 105 to a second location. The second location can be in an area different than a location of the apparatus 100. The second location can be in a same area as the location of the apparatus 100.

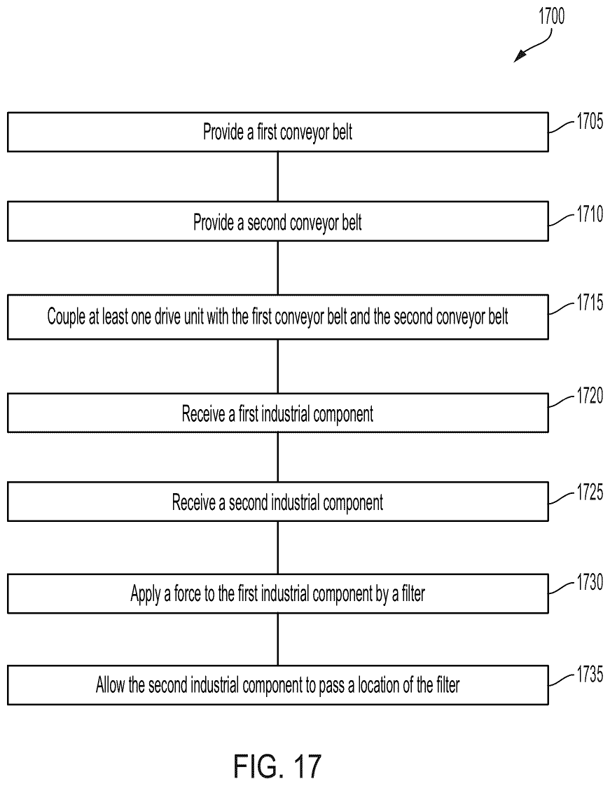

FIG. 17, among others, depicts a flow chart of a method 1700. The method 1600 can be a method of organizing industrial components 105. For example, the method 1700 can be a method of organizing industrial components 105 using the apparatus 100. The method 1700 can include one or more of ACTS 1705-1735. Each of ACTS 1705-1735 can be performed in the order depicted in FIG. 17 or in some other order. Although described below as pertaining to the apparatus 100 disclosed herein, it is understood that the method 1700 can be performed using another apparatus, for example.

The method 1700 can include providing the first conveyor belt 110 at ACT 1705. For example, at ACT 1705, the first conveyor belt 110 can be provided along a path from a first location to a second location that the industrial components 105 are to travel through.

The method 1700 can include providing the second conveyor belt 115 at ACT 1710. For example, the second conveyor belt 115 can be spaced apart from the first conveyor belt 110. The spacing between the second conveyor belt 115 and the first conveyor belt 110, at ACT 1710, can be determined dependent on a size of the 105, among others. The second conveyor belt 115 provided can be a same type or a different type as the first conveyor belt 110. For example, the second conveyor belt 115 can span along a second path different than the path the first conveyor belt 110 spans from. The first conveyor belt 110 or the second conveyor belt 115 can be straight, curved, non-linear, or some combination thereof, among others. For example, the second conveyor belt 115 can have a S-curve, a U-shape, or a helix shape.

The method 1700 can include coupling at least one drive unit 125 with the first conveyor belt 110 and the second conveyor belt 115 at ACT 1715. The drive unit 125 can be coupled with the first conveyor belt 110 and the second conveyor belt 115 to provide drive the first conveyor belt 110 and the second conveyor belt 115 to operate. For example, at ACT 1715, the first conveyor belt 110 and the second conveyor belt 115 can be driven to operate at a first speed and at a second speed, respectively, by the drive unit 125. The first speed can be the same as or different than the second speed. A second drive unit 125 can be coupled with at least one of the first conveyor belt 110 or the second conveyor belt 115.

The method 1700 can include receiving a first industrial component 105 at ACT 1720. For example, the first conveyor belt 110 and the second conveyor belt 115 can receive the first industrial component 105. The first industrial component 105 can have the first orientation 405 while on the first conveyor belt 110 and the second conveyor belt 115. For example, an orientation of the first industrial component 105 before on the first conveyor belt 110 and the second conveyor belt 115 can be different than the first orientation 405.

The method 1700 can include receiving a second industrial component 105 at ACT 1725. For example, the first conveyor belt 110 and the second conveyor belt 115 can receive the second industrial component 105. The second industrial component 105 can have the second orientation 505 while on the first conveyor belt 110 and the second conveyor belt 115. The second orientation 505 can be different than the first orientation 405.

The industrial components 105 received at ACT 1720 and ACT 1725 (e.g., the first industrial component 105, the second industrial component, etc.) can be received by the transport element 210. The transport element 210 can transport the industrial components 105 to the first conveyor belt 110 and the second conveyor belt 115. For example, the transport element 210 can receive the industrial components 105 from the container 205 and transport the industrial components 105 from the container 205 to the first conveyor belt 110 and the second conveyor belt 115.

The method 1700 can include applying a force to the first industrial component 105 at ACT 1730. For example, the force can be applied by the filter 130. The filter 130 can selectively remove the industrial components 105 from the first conveyor belt 110 and the second conveyor belt 115. For example, based on the first industrial component 105 having the first orientation 405, the filter 130 can remove the first industrial component 105 from the first conveyor belt 110 and the second conveyor belt 115. The filter 130 can remove the first industrial component 105 to the container 205.

The method 1700 can include allowing the second industrial component 105 to pass a location of the filter 130 at ACT 1735. For example, the filter 130 can, based on the second industrial component 105 having the second orientation 505, not remove the second industrial component 105 from the first conveyor belt 110 and the second conveyor belt 115, such that the second industrial component 105 can pass the location of the filter 130. As such, the method 1700 allows for the industrial components 105 to be organized through use of the first conveyor belt 110, the second conveyor belt 115, and the filter 130.

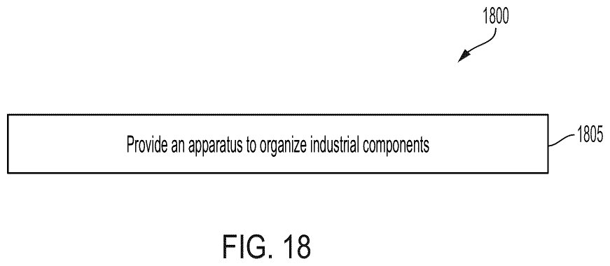

FIG. 18, among others, depicts a flow chart of a method 1800 of providing the apparatus 100. For example, the apparatus 100 can be provided to organize industrial components 105. The apparatus 100 can include the first conveyor belt 110. The first conveyor belt 110 can span along a path from a first location to a second location. The path can be straight, non-linear, or curved, among others. The apparatus 100 can include the second conveyor belt 115. The second conveyor belt 115 can be spaced apart from the first conveyor belt 110. The second conveyor belt 115 can be a same type or a different type as the first conveyor belt 110. The apparatus 100 can include the drive unit 125. For example, the drive unit 125 can be coupled with the first conveyor belt 110 and the second conveyor belt 115. The drive unit 125 can drive the first conveyor belt 110 and the second conveyor belt 115 to operate at a same speed or at a different speed.

The first conveyor belt 110 and the second conveyor belt 115 are to receive the first industrial component 105. The first industrial component 105 can have the first orientation 405. The first industrial component 105 can have the first orientation 405 while on the first conveyor belt 110 and the second conveyor belt 115, such that an orientation of the first industrial component 105 when not on the first conveyor belt 110 and the second conveyor belt 115 can be different than the first orientation 405. The first conveyor belt 110 and the second conveyor belt 115 are to receive the second industrial component 105. The second industrial component 105 can have the second orientation 505 while on the first conveyor belt 110 and the second conveyor belt 115. The apparatus 100 can include the filter 130. For example, the filter 130 can include at least one of a mechanical filter with a structural blocker 135 or a pneumatic filter with a nozzle 140. The filter 130 can apply a force to the first industrial component 105 based on the first industrial component 105 having the first orientation 405. The force applied to the first industrial component 105 can remove the first industrial component from the first conveyor belt 110 and the second conveyor belt 115. The filter 130 can allow, based on the second industrial component 105 having the second orientation 505, the second industrial component 105 to pass a location of the filter 130.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The embodiments of the present disclosure may be implemented using computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

What is claimed is:

1. An apparatus to organize industrial components, comprising:
a first conveyor belt;
a second conveyor belt spaced apart from the first conveyor belt;
a drive unit coupled with the first conveyor belt and the second conveyor belt;
the first conveyor belt and the second conveyor belt to receive a first industrial component having a first orientation;
the first conveyor belt and the second conveyor belt to receive a second industrial component having a second orientation different than the first orientation;
a filter to apply a force to the first industrial component based on the first orientation to remove the first industrial component from the first conveyor belt and from the second conveyor belt; and
the filter to allow, based on the second orientation, the second industrial component to pass a location of the filter.

2. The apparatus of claim 1, comprising:
at least one of the first industrial component or the second industrial component including a dowel, a fastener, a screw, a bolt, a nut, a pin, or a rod.

3. The apparatus of claim 1, comprising:
the drive unit including a motor to drive the first conveyor belt and the second conveyor belt at a same speed.

4. The apparatus of claim 1, comprising:
the drive unit to drive the first conveyor belt to operate at a first speed; and
the drive unit to drive the second conveyor belt to operate at a second speed, the second speed different from the first speed.

5. The apparatus of claim 1, comprising:
the filter including at least one of a pneumatic filter or a mechanical filter.

6. The apparatus of claim 1, wherein the filter is a first pneumatic filter at a first location, comprising:
a second pneumatic filter at a second location different than the first location;
the first conveyor belt and the second conveyor belt to receive a third industrial component having a third orientation;
the first pneumatic filter to apply a first force to the first industrial component based on the first orientation to remove the first industrial component from the first conveyor belt and from the second conveyor belt;
the first pneumatic filter to allow, based on the third orientation, the third industrial component to pass the first location; and
the second pneumatic filter to apply a second force to the third industrial component based on the third orientation to remove the third industrial component from the first conveyor belt and from the second conveyor belt.

7. The apparatus of claim 1, comprising:
the filter including a pneumatic filter to apply the force, the force applied at an angle relative to a longitudinal axis of the first conveyor belt;
the first conveyor belt and the second conveyor belt to receive a third industrial component having a third orientation; and
the pneumatic filter to remove, based on the angle, the third industrial component from the first conveyor belt and from the second conveyor belt.

8. The apparatus of claim 1, comprising:
the filter including a first pneumatic filter at a first location positioned along a first side of the first conveyor belt and the second conveyor belt; and
the filter including a second pneumatic filter at a second location different that the first location and positioned along a second side of the first conveyor belt and the second conveyor belt.

9. The apparatus of claim 1, comprising:
the filter including a mechanical filter; and
the mechanical filter contacting the first industrial component to remove the first industrial component from the first conveyor belt and from the second conveyor belt.

10. The apparatus of claim 1, comprising:
the filter including a mechanical filter having a first location;
the first conveyor belt and the second conveyor belt to receive a third industrial component having a third orientation;
the mechanical filter to, based on the third orientation, contact the third industrial component to move the third industrial component to the second orientation; and
the mechanical filter to allow, based on the third industrial component having the second orientation, the third industrial component to pass the first location.

11. The apparatus of claim 1, comprising:
the first conveyor belt having a first height from a base of the apparatus; and
the second conveyor belt having a second height from the base, the first height greater than the second height.

12. The apparatus of claim 1, comprising:
the first conveyor belt having a first height from a base of the apparatus; and
the second conveyor belt having a second height from the base, the first height equal to the second height.

13. The apparatus of claim 1, comprising:
a container to store the first industrial component and the second industrial component, the first conveyor belt and the second conveyor belt to receive the first industrial component and the second industrial component from the container; and
the filter to remove the first industrial component from the first conveyor belt and the second conveyor belt into the container.

14. The apparatus of claim 1, comprising:
a transport element to transport the first industrial component and the second industrial component from a first position to the first conveyor belt and the second conveyor belt, the first position not on the first conveyor belt and the second conveyor belt.

15. The apparatus of claim 1, comprising:
a container to store the first industrial component and the second industrial component;
a transport element to receive the first industrial component from the container and transport the first industrial component to the first conveyor belt and the second conveyor belt; and
the transport element to receive the second industrial component from the container and transport the second industrial component to the first conveyor belt and the second conveyor belt.

16. The apparatus of claim 1, comprising:
a funneling member, the first conveyor belt and the second conveyor belt to receive the first industrial component from the funneling member;
the first conveyor belt and the second conveyor belt to receive the second industrial component from the funneling member;
the funneling member to receive a third industrial component, the third industrial component having a third orientation different than the second orientation; and
the funneling member to, based on the third orientation, apply a force to the third industrial component to move the third orientation to the second orientation, the first conveyor belt and the second conveyor belt to receive the third industrial component having the second orientation.

17. The apparatus of claim 1, comprising:
a handling system, the handling system positioned at a location past the filter; and
the handling system to receive the second industrial component and remove the second industrial component from the first conveyor belt and the second conveyor belt.

18. A method of organizing industrial components with an apparatus, comprising:
providing a first conveyor belt;
providing a second conveyor belt spaced apart from the first conveyor belt;
coupling at least one drive unit with the first conveyor belt and the second conveyor belt, at least one of the first conveyor belt or the second conveyor belt is a non-linear conveyor belt;
receiving, by the first conveyor belt and the second conveyor belt, a first industrial component having a first orientation;
receiving, by the first conveyor belt and the second conveyor belt, a second industrial component having a second orientation;
applying, by a filter, a force to the first industrial component based on the first orientation to remove the first industrial component from the first conveyor belt and from the second conveyor belt; and
allowing, by the filter, the second industrial component, based on the second orientation, to pass a location of the filter.

19. The method of claim 18, comprising:
transporting the first industrial component and the second industrial component to the first conveyor belt and the second conveyor belt with a transport element, the transport element receiving the first industrial component and the second industrial component from a container.

20. A method, comprising:
providing an apparatus to organize industrial components, the apparatus comprising:
a first conveyor belt;
a second conveyor belt spaced apart from the first conveyor belt;
a drive unit coupled with the first conveyor belt and the second conveyor belt;
the first conveyor belt and the second conveyor belt to receive a first industrial component having a first orientation;
the first conveyor belt and the second conveyor belt to receive a second industrial component having a second orientation different than the first orientation;
a filter to apply a force to the first industrial component based on the first orientation to remove the first industrial component from the first conveyor belt and from the second conveyor belt; and
the filter to allow, based on the second orientation, the second industrial component to pass a location of the filter.
